(19) United States
(12) Patent Application Publication
(10) Pub. No.: US 2015/0142612 A1
(43) Pub. Date: May 21, 2015

(54) MULTI-MODAL TRANSACTION ENGINE FOR MOBILE RETAIL SYSTEMS

(71) Applicant: GUESTLOGIX, INC., TORONTO (CA)

(72) Inventors: Ramez Hanna, North York (CA); Paul Morin, Toronto (CA); Ilia Kostov, Southlake, TX (US); Kamal Singhee, Irving, TX (US); Joel Atkin, Toronto (CA)

(21) Appl. No.: 14/495,854

(22) Filed: Sep. 24, 2014

Related U.S. Application Data
(60) Provisional application No. 61/881,784, filed on Sep. 24, 2013.

(51) Int. Cl. G06Q 20/08; G06Q 30/06

(52) U.S. Cl. CPC G06Q 20/085; G06Q 30/0635
USPC 705/26.81

(57) ABSTRACT

Autonomous operation of a mobile retailing computing system. In one aspect of the invention, an onboard server situated in a public transportation vehicle establishes communication with a plurality of client devices each client device displaying products offered for sale from multiple different merchants and coordinates a purchase transaction in which payment is accepted in exchange for a products from a plurality of the different merchants. Customer information, purchased product information, and payment information is obtained from each of the plurality of client devices. Communication is established with a payment integration server over a wide-area network connection to enable processing of payment transactions with a plurality of different acquiring banks corresponding to different ones of the plurality of merchants.

### PRIOR APPLICATION

This application claims the benefit of U.S. Provisional Application No. 61/881,784 filed Sep. 24, 2013, the disclosure of which is incorporated by reference herein.

### FIELD OF THE INVENTION

The invention relates generally to information systems and computer networking and, more particularly, to computer-based systems and methods having a specially-purposed architecture for processing transactions in mobile environments where products are offered for sale from various merchants and where a constant or reliable wide-area network connection is oftentimes unavailable.

### BACKGROUND OF THE INVENTION

Today's travel industry is faced with a myriad of economic and operational challenges, from price pressure to rising fuel prices, to labor issues, to competition from other carriers and alternative loyalty programs, to name a few. In recent years, airlines have turned to a variety of alternative sources of revenue such as baggage check fees, charging for meals, and charging for the use of in-flight entertainment systems. Unfortunately, many of these new fees are alienating customers who have been accustomed to receiving services such as baggage checking and meals, without having to pay extra for them. Carriers are therefore seeking out opportunities to provide services that add value to their customers' travel experience, which is expected to be much better received than tactics of exacting new fees from existing services.

Airline operators, for instance, first discovered ancillary revenue opportunities through advertising sales in their branded on-board magazines and buy-on board programs involving duty-free goods. This eventually spread to online bookings and self-check-in options. Today, airlines are using their web sites to sell seats, insurance, car rentals and hotel reservations. Others have extended this buying to on-board programs to provide a la carte meals and drinks, lottery tickets, phone cards, on-demand entertainment, and more. With the advent of on-board Wi-Fi communications airlines are moving into a position to reap more profits from their captive audiences than ever before.

Although the opportunity to tap the market of in-transit passengers has been known for decades, a number of particular challenges has prevented deployment of a commercial infrastructure to in-transit passengers. For example, crew personnel are not retail sales staff and would need to be trained to acquire retail sales skills. Also, there are practical difficulties in transacting with customers who are passengers seated throughout the airplane. Furthermore, importantly, the retail environment in a moving vehicle is dynamic, meaning that the inventory and services available for purchase are entirely dependent on the unique characteristics of each flight leg.

U.S. Pat. No. 8,328,094, the disclosure of which is incorporated by reference herein, describes a solution for linking a passenger's travel itinerary to mobile retail environments with their specific product or service offerings, and for coordinating sales, provisioning, and other critical activities in connection with conducting sales or delivery of goods and services to or from those mobile retail environments. This approach facilitates pre-ordering goods or services for delivery to the customer on a vehicle or at a destination. A Web-based application is contemplated for pre-ordering goods prior to boarding the vehicles, which is linked to a back office system that tracks flight schedules, traveler itineraries, provisioning and stocking information, etc. On board the vehicles, point-of-sale devices that can display available goods or services, guide customers through a shopping session, and even take a payment, are described. These may take the form of a hand-portable device that can be operated or brought to customers by flight attendants, or a seat-back entertainment system. These devices are updated with inventory and other relevant information whenever a network connection is, or becomes, available, such as at destination points.

U.S. Pre-Grant Patent Application Publication No. 2014/0100976, the disclosure of which is incorporated by reference herein, describes a system supporting the use of personal portable devices, such as smartphones, tablets, and the like, for off-line shopping in mobile retail environments.

One problem that is encountered in administering mobile retail environments appears when the carrier acts as a facilitator of the mobile retail environment, and not the always the seller of all of the goods or services being offered in the environment. The passenger (who is the purchaser in the present context) may wish to purchase a variety of goods or services during a shopping session, and these goods or services can be sold by different merchants. For instance, theater tickets can be sold by a ticket vendor, in-flight food can be sold by the carrier, a tour at a destination can be sold by a tour operator, and an item to be delivered to the purchaser's home address can be sold by a store operator. Each of the merchants can have its own payment processing arrangement (e.g., with a different acquiring bank) for accepting credit/debit card payments. Conventionally, purchases from separate merchants are handled by individually shopping and transacting with each merchant, which is inconvenient and fatiguing for the customer. An annoyed customer is less likely to continue shopping, or re-start shopping soon after having spent time on completing a payment. A solution is needed to streamline the shopping and transacting experience for the customer.

Another challenge for operators of mobile retail environments is that customers tend to use different touch points for interacting with a mobile retail environment. A given passenger on an airliner can use his or her mobile phone, tablet, laptop computer, and in-flight entertainment device interchangeably during a flight or travel itinerary involving connections between flights. Between flights, travelers can use e-shopping kiosks and publicly-available Internet-connected computers as well. A traveler's shopping session can be interrupted for a variety of reasons, such as running out of battery power in a particular device, regulations limiting the use of certain types of portable electronic devices at low altitudes, receiving a meal, having to use the lavatory, having to board a flight or de-plane, etc. If this happens, a passenger is less likely to return to his or her shopping session if it must be re-started, particularly if selected items are lost from an electronic shopping cart or if payment information had already been entered and now must be re-entered.

Another problem faced particularly by transportation carriers is that on-board systems have intermittent connectivity to the Internet, or to wide-area networks during which a large amount of information needs to be exchanged with a centralized server. Such information includes customer, sales, and payment details, as well as product inventory and other such data essential to the administration of mobile retail systems. When connections are restored following a service interruption, it may be for an insufficient amount of time to complete essential data transfer, such as payment-related transactional information. Also, some merchants who deal in higher-value goods or services may require certain payment transactions to be authorized before completing the sale. Intermittent connections to the Internet or wide-area network can interfere with these types of sales. Solutions are needed to address some of these connection-related challenges.

### SUMMARY OF THE INVENTION

One aspect of the invention is directed to a mobile retailing computing infrastructure that includes an onboard server situated in a public transportation vehicle, the onboard server including computing hardware including a processor, data storage, and communication circuitry, the data storage containing instructions. When the instructions are executed by the computing hardware, they cause the computing hardware to become a special-purpose machine that carries out tangible data processing functionality to create a system that has never heretofore been realized, and is one that enables new ways of facilitating commerce on moving vehicles. The onboard server establishes communication with a plurality of client devices over a local area network, with each client device including a mobile retailing engine that causes the client device to display products offered for sale from multiple different merchants and to execute a user-interactive electronic shopping cart process that coordinates a purchase transaction in which payment is accepted from a user in exchange for a user-selected plurality of products from a plurality of the different merchants.

The onboard server executes a payment processing engine to obtain customer information, purchased product information, and payment information from each of the plurality of client devices in response to entry of a purchase and payment in that client device.

Further, the onboard server establishes communication with a centralized payment integration server over a wide-area network connection to transmit transaction customer information, purchased products information, and payment information, such that the centralized payment integration server processes payment transactions with a plurality of different acquiring banks corresponding to different ones of the plurality of merchants.

In a related embodiment, the onboard server establishes communication with a plurality of client devices over a local area network, each client device including a mobile retailing engine that causes the client device to display products offered for sale and to execute a user-interactive electronic shopping cart process that coordinates an initiated purchase transaction in which payment is accepted from a user in exchange for a user-selected plurality of products from at least one merchant.

The onboard server executes a payment processing engine to obtain customer information, purchased product information, and payment information from each of the plurality of client devices in response to entry of a purchase and payment in that client device.

Also, the onboard server executes a data replication engine to synchronize the obtained customer information, purchased product information, and payment information with the plurality of client devices such that, for every one of the plurality of client devices that is uniquely associated with a particular at least one user, only information relating to that at least one user is synchronized; and for every one of the plurality of client devices that is not uniquely associated with a particular at least one user, information relating to all users having initiated purchase transactions is synchronized.

Further, the onboard server establishes communication with a centralized payment integration server over a wide-area network connection to transmit transaction customer, purchased products information, and payment information, such that the centralized payment integration server processes payment transactions with at least one acquiring bank corresponding to the at least one merchant.

In a related aspect of the invention, the onboard server establishes communication with a plurality of client devices over a local area network, each client device executing a mobile retailing engine that causes the client device to display products offered for sale by a plurality of different merchants, each merchant being associated with a specific payment acceptance policy; and execute a user-interactive electronic shopping cart process that coordinates an initiated purchase transaction in which payment is accepted from a user in exchange for a user-selected set of at least one product from at least one merchant of the plurality of merchants.

The onboard server executes a payment processing engine to obtain customer information, purchased product information, and payment information from each of the plurality of client devices in response to entry of a purchase and payment in that client device, and to read the specific payment acceptance policy corresponding to the at least one merchant from which the at least one product is to be purchased according to the initiated purchase transaction.

For each of the at least one merchant, the onboard server computes a comparison of the corresponding specific payment acceptance policy against the initiated purchase transaction to determine whether a purchase approval requirement condition is met. In response to the comparison indicating that the purchase approval requirement is not met, it generates an approval of the initiated purchase transaction. Moreover, in response to the comparison indicating that the purchase approval requirement is met, the onboard server obtains a transaction authorization via wide-area network communication with a centralized payment integration server. The payment integration server processes payment transactions with at least one acquiring bank corresponding to the at least one merchant.

A number of other advantages will become apparent from the following Detailed Description of the Preferred Embodiments.

### BRIEF DESCRIPTION OF THE DRAWINGS

The invention may be more completely understood in consideration of the following detailed description of various embodiments of the invention in connection with the accompanying drawings, in which:

FIG. 1A is a high-level system architecture diagram depicting of a system facilitating mobile retail sales according to one embodiment of the invention.

FIG. 1B is a block diagram depicting the structure of an onboard server according to one embodiment.

FIG. 2 is a flow diagram illustrating various functions and their interactions carried out by a client device, an onboard server, and a payment integration server according to one embodiment of the invention.

FIG. 3 is a flow diagram illustrating an exemplary algorithm carried out by the onboard server to distribute transaction and payment information among devices communicating in the vehicle LAN according to one embodiment.

FIGS. 4A and 4B are flow diagrams illustrating example algorithms that may be executed by an onboard server to determine whether to authorize payments in the absence of a working WAN connection, and whether to transmit payment information using a high-priority queue or a lower-priority batch method according to various embodiments.

FIG. 5 is a diagram illustrating in greater detail a computer system on which aspects of the invention may be implemented according to various embodiments.

FIG. 6 is a diagram illustrating an exemplary hardware and software architecture of a computer system such as the one depicted in FIG. 5, in which various interfaces between hardware components and software components are shown.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE PREFERRED EMBODIMENTS

Aspects of the invention are directed to automated systems and methods for operating the same, for facilitating purchases and payment processing in a mobile retail environment. The retail environment is termed mobile because the place where the shoppers are located is a vehicle, such as an aircraft, train, ship, bus, automobile, and the like. For the sake of simplicity, the embodiments of the invention detailed below shall be described in the context of an aircraft, where the shoppers, or customers, are passengers that are either on board the aircraft, or are persons who will be present on board the aircraft at a specified future time. In this case, the operator of the aircraft, or the carrier, is an airline company. It will be understood, however, that the invention as a whole is not limited to the case of airlines and aircraft as the mobile environment in which the mobile retail environment is facilitated, unless such a limitation is expressly made in a claim, in which case only that claim shall be so limited. Persons of skill in the relevant arts will appreciate that principles of the invention can be applied to any suitable type of vehicle and transportation service.

Also, aspects of the present invention can be implemented as part of a computer system. The computer system can be one physical machine, or can be distributed among multiple physical machines, such as by role or function, or by process thread in the case of a cloud computing distributed model. In various embodiments, aspects of the invention can be configured to run in virtual machines that in turn are executed on one or more physical machines. It will be understood by persons of skill in the art that features of the invention may be realized by a variety of different suitable machine implementations.

The goods or services for sale in the mobile retail environment can be purchased onboard, with fulfillment, i.e., delivery, of the goods or services taking place onboard and en route, or in the future, such as during a subsequent leg of the traveler-purchaser's travel itinerary, at an intermediate or final destination, or at the traveler's home address, for instance. For the sake of brevity, goods or services shall be collectively referred to herein as simply “products.”

A wide variety of products are contemplated as being offered for sale via the mobile retail environment. For example, sold products to be delivered onboard include in-flight entertainment media, food/beverages for purchase, equipment rental (e.g., headphones, game systems, etc.). Products to be delivered at an intermediate or final destination can include hotel stays, priority club access, spa or massage services at airport salons, ground transportation, theater or sporting event tickets, tour tickets, duty-free items, and the like. Products that may be purchased onboard for delivery to the traveler's home address can include any deliverable product, from apparel to furniture, tools, jewelry, electronics, health and beauty products, and all types of services being offered for sale. As discussed above, such a wide collection of product offering can be provided from a plurality of very different merchants, who can be various vendors or suppliers, as well as from the carrier company and its industry partners.

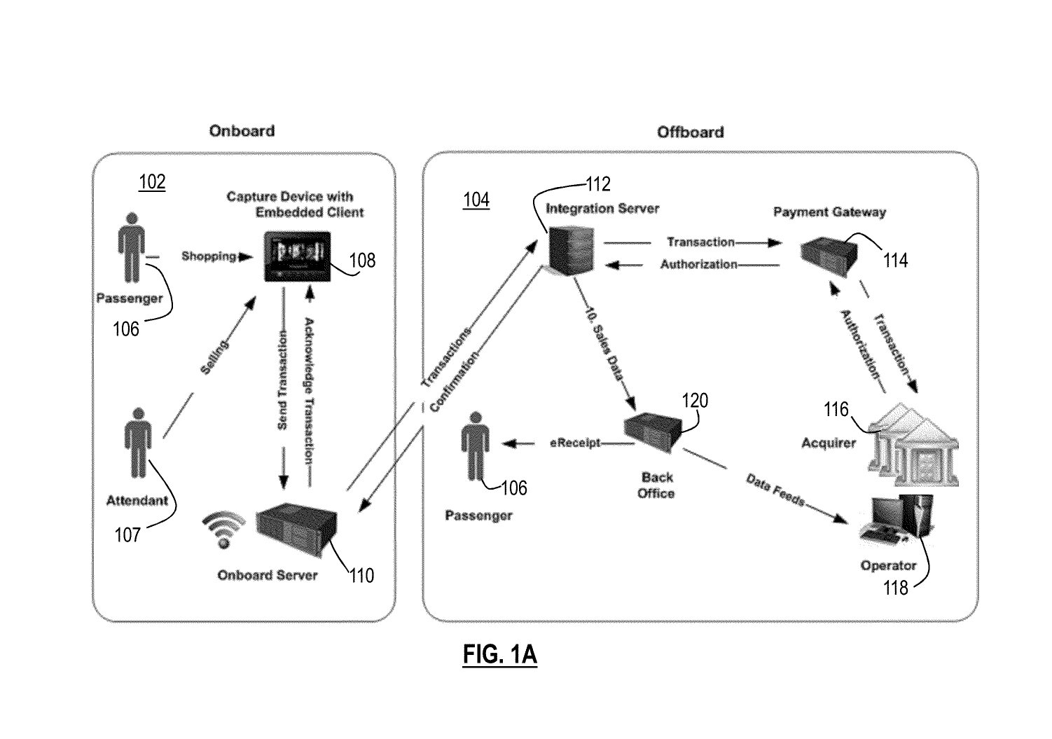

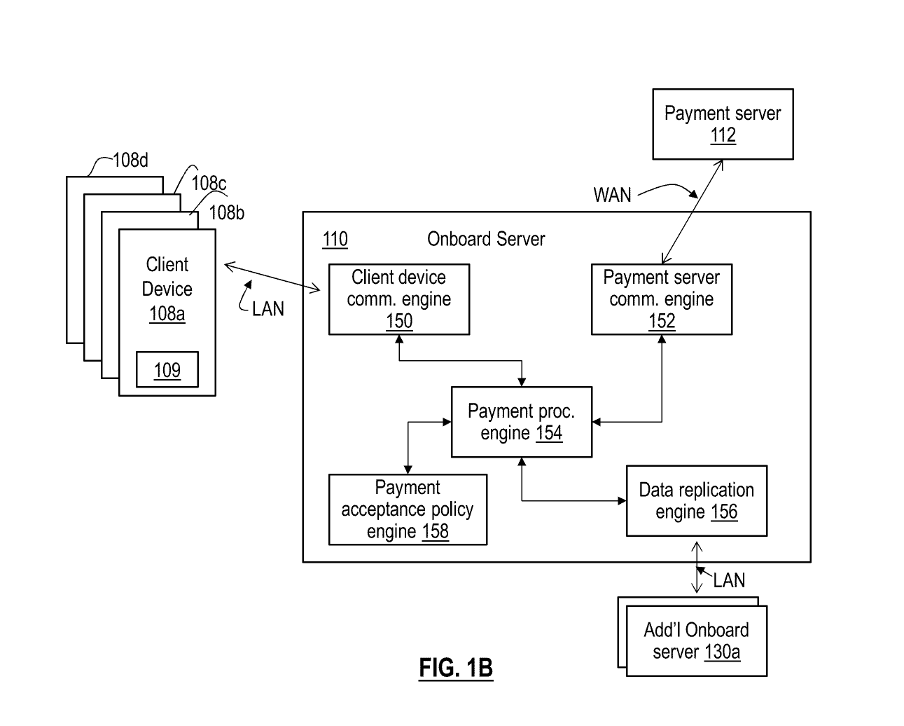

Turning now to FIG. 1A, a high-level system architecture is depicted of a system facilitating mobile retail sales according to one embodiment. As depicted, the system includes onboard components 102, and offboard components 104. The onboard components are those which reside in a vehicle—an aircraft, train, bus, ship, etc. Although only one is shown in FIG. 1A, it should be understood that the system can support a large plurality—dozens, or even hundreds, of individual onboard component sets 102, which can be associated with a variety of different carriers. Offboard components 104 are generally installed at one or more fixed locations. In the case of multiple locations for offboard components 104, each location can serve a particular geographic area, jurisdiction, etc. Optionally, multiple locations can have redundant data storage and functionality to provide failover, disaster recovery, excess capacity, and other reliability and service quality-enhancing features. Offboard components 104 can be considered to be centralized—in the sense that each set of offboard components 104 serves numerous sets of onboard components 102.

Passenger 106 represents one of a plurality of traveling customers, or end-users, of the system. Each passenger 106 interfaces with the system using a client device 108, also referred to as a touch-point, capture device, point-of sale terminal, or the like. A variety of device types are contemplated in taking this role. These include shared devices that can serve multiple unrelated passengers 106, such as vehicle-assigned portable point-of-sale terminals carried by flight attendants 107, in-flight entertainment (IFE) systems such as rentable tablet devices or seat-back devices, and the like. These devices typically have wired or wireless connectivity with a vehicle local area network, such as a Wi-Fi network defined in the IEEE 102.11 standard. Client devices 108 can also be a passenger's 106 or crew member's 107 own personal device that can connect to the vehicle LAN. Client device 108 can be a smartphone, tablet, laptop PC, netbook, or any other portable information device. In one embodiment, the client device 108 executes an specially-designed and installed application program, commonly referred to as an app, that includes a variety of functions facilitating a graphical user interface (GUI), secure data storage and communications, fault recovery, etc., which is exclusively for use with the system according to various aspects of the invention.

Onboard server 110 in FIG. 1A represents one or several computing devices installed in the vehicle to which multiple client devices 108 can connect and exchange relevant information. For example, onboard server 110 receives a mobile store definition from the operator of the mobile retail environment. The mobile store definition can be specific to the vehicle, its passengers, the departure, and arrival points, and can have a unique set of products offered for sale which differs from other mobile retail environments of other vehicles. In one embodiment, onboard server 110 distributes instances of the mobile store definition to each of the client devices 108, such that each client device 108 can store the current product offering, and execute a mobile retailing engine that facilitates a shopping experience for the passenger 106, including displaying products for sale, providing searching and tagging functions, providing an electronic shopping cart that stores products selected for purchase and their quantities to be purchased, taking payment information from passengers, displaying confirmation of sale completion, displaying transaction history, facilitating returns, etc. Taking payments can include taking credit card numbers and related information, gift cards, vouchers, proprietary tokens, alternative digital currencies, etc., performing basic verification of card number validity based on number generation algorithms, blacklists, and the like.

In one embodiment, when a sale is made via a client device 108, the user, product, and payment information is sent to the onboard server 110 by the client device over the vehicle LAN. In this way, the onboard server 110 can collect a plurality of transactions from the multiple client devices 108. To consummate the transaction, the payment must be approved. Various approaches for approving payments with and without live wide-area network (WAN) connections are discussed below according to aspects of the invention. Also, payment needs to be reconciled, or settled, between the passenger 106 and the merchants from whom the products are purchased.

Accordingly, in the embodiment depicted, onboard server 110 transmits the customer information, purchased products information, and payment-related information to payment integration server 112. This transmission takes place over a WAN, only when the WAN is available. Payment integration server 112 collects such information from a plurality of onboard servers 110 from a plurality of different vehicles, possibly even from different carriers. The purchased products information includes merchant information corresponding to those products, or information associating each purchased product with the merchant selling that product.

Integration server 112 proceeds to process payment settlement. In the embodiment depicted, payment gateway 114 is used to communicate with one or more acquiring banks 116, each of which serves one or more of the merchants. In this way, the system can support simultaneous sales by multiple unaffiliated merchants through a single shopping cart presented to passenger 106. Integration server 112 or payment gateway 114 associates each merchant identifier with that merchant's acquiring bank 116 and, optionally, with that merchant's unique payment-acceptance policy. Integration server 112 can also transmit relevant sales data to mobile store operator 118 for reporting purposes, as well as to back office system 120, which logs transactions and related business and technical system performance data, and generates electronic receipts to be transmitted to passengers 106 via email or other communication channel.

FIG. 1B is a block diagram depicting the structure of onboard server 110 according to one embodiment. The system includes various engines, each of which is constructed, programmed, configured, or otherwise adapted, to carry out a function or set of functions. The term engine as used herein means a real-world device, component, or arrangement of components implemented using hardware, such as by an application specific integrated circuit (ASIC) or field-programmable gate array (FPGA), for example, or as a combination of hardware and software, such as by a microprocessor system and a set of program instructions that adapt the engine to implement the particular functionality, which (while being executed) transform the microprocessor system into a special-purpose device. A engine can also be implemented as a combination of the two, with certain functions facilitated by hardware alone, and other functions facilitated by a combination of hardware and software. In certain implementations, at least a portion, and in some cases, all, of a engine can be executed on the processor(s) of one or more computers that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of suitable configurations, and should generally not be limited to any particular implementation exemplified herein, unless such limitations are expressly called out. In addition, a engine can itself be composed of more than one sub-engines, each of which can be regarded as a engine in its own right. Moreover, in the embodiments described herein, each of the various engines corresponds to a defined functionality; however, it should be understood that in other contemplated embodiments, each functionality may be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

Onboard server 110 includes client device communication engine 150 that is programmed, constructed, or otherwise configured, to communicate with multiple client devices 108a-108d via the vehicle LAN. Each client device 108 includes a mobile retailing engine 109, which can be implemented via a specialized app, according to one embodiment. Payment server communication engine 152 is programmed, constructed, or otherwise configured, to communicate with at least one payment integration server 112 via a WAN when that WAN is available. Payment processing engine 154 is programmed, constructed, or otherwise configured, to collect each set of transaction-related information from each purchase made via client device 108, to authorize the payment according to preconfigured rules or criteria, and pass information between the various engines to facilitate operation of the system.

In a related embodiment, payment acceptance policy engine 158 is configured with merchant-specific payment acceptance policies and logic for applying those policies. payment acceptance policy engine 158 works with payment processing engine 154 to determine if and when payment can be authorized in the absence of a WAN connection to enable completion of purchases during transit.

In another related embodiment, data replication engine 156 is configured to exchange payment and purchase history information with other devices over the vehicle's LAN, such as with other onboard servers, if available, and with client devices according to certain embodiments.

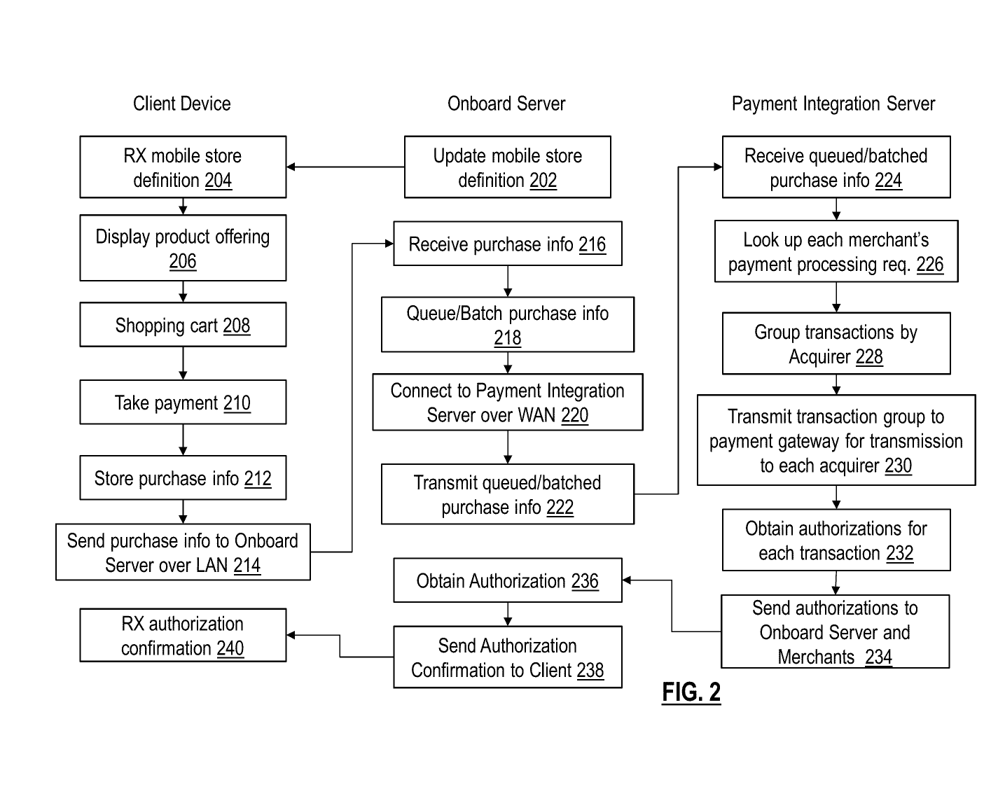

FIG. 2 is a flow diagram illustrating various functions and their interactions carried out by a client device 108, onboard server 110, and payment integration server 112 according to one embodiment. At 202 the onboard server, having had its mobile store definition configured from back office system 120 previously, updates each client device with that mobile store definition. As shown, the mobile store definition update is received by the client device at 204. At 206, the onboard shopping experienced is initiated, and the product offering is interactively displayed for to the traveler-user via graphical user interface. The traveler selects products to purchase, and the client device coordinates the collection of the various selected products, which may be offered by multiple different merchants, into a single shopping cart at 208. At 210, payment is taken by the client device, and the purchase-related information on the products, payment, and user, is stored at 212. at 214, this information is sent to the onboard server, which receives it at 216.

At 218, the purchase-related information is prepared by the onboard server to be transmitted to payment integration server. As will be detailed below, this can be done via high-priority transmission, which is referred to herein as being queued for transmission at the next available opportunity, or via a lower-priority transmission, which is referred to herein as being batched (and optionally combined with other purchase information from other client devices), according to one related embodiment. At 220, onboard server 220 connects over the WAN to the payment integration server when the WAN is, or becomes, available. At 222, the queued and batched information is sent, which is received at 224. At 226, payment integration server 226 looks up each merchant's customized payment processing requirements, such as which acquiring bank to use, etc., and optionally groups transactions by acquiring bank to batch and streamline communications with the acquirers at 228. At 230 the communications with the acquiring banks is carried out, for example, via a payment gateway communications system.

At 232, authorizations are obtained for each transaction and, at 234, those authorizations are sent to the onboard server over the WAN. The authorizations are received at 236. At 238, the authorization confirmations are associated with each client device, and transmitted over the vehicle LAN. These confirmations are received at 240. Also at 240, and to the extent needed, information is sent to other onboard devices to notify an attendant or service provider to complete the delivery of the product.

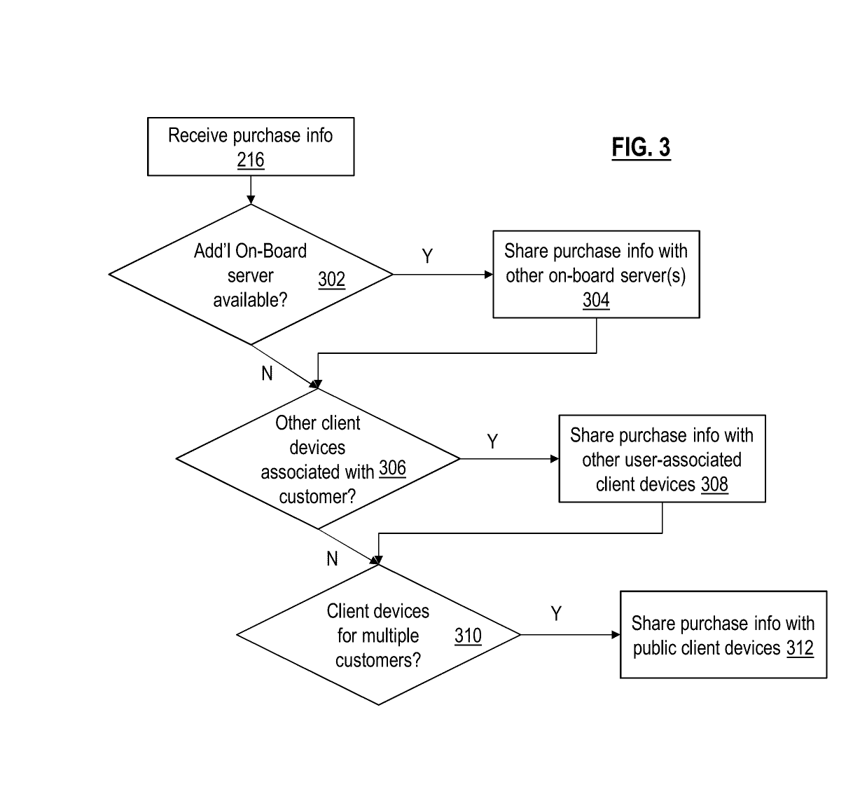

FIG. 3 is a flow diagram illustrating an exemplary algorithm carried out by the onboard server to distribute transaction and payment information among devices communicating in the vehicle LAN. according to one embodiment The process begins at 216, when the onboard server receives purchase information. Next, at 302, onboard server determines if there is any other onboard server with which information may be replicated. In the affirmative case, information is shared at 304. This can be accomplished by a data pushing or polling scheme according to various contemplated implementations.

At 306, the onboard server computes a decision as to whether other client devices are associated with the same customer (i.e., traveler, purchaser, user). This can be true if a given customer has more than one device on the LAN (e.g., smartphone, tablet, laptop, etc.). In this case, the customer's purchase and payment information is distributed to those other devices. Notably, personal devices of customers do not receive any information about other customers' transactions, etc.

At 310, the onboard server determines if there are client devices that serve the public, i.e., multiple customers. An example of such a client device is a portable point-of-sale device that is carried by flight attendants. Information about the purchase received at 216 is thus shared with any such available public client device.

Preferably, the purchase and payment data is handled and stored securely, such that only authorized, authenticated processes are given rights to read that data.

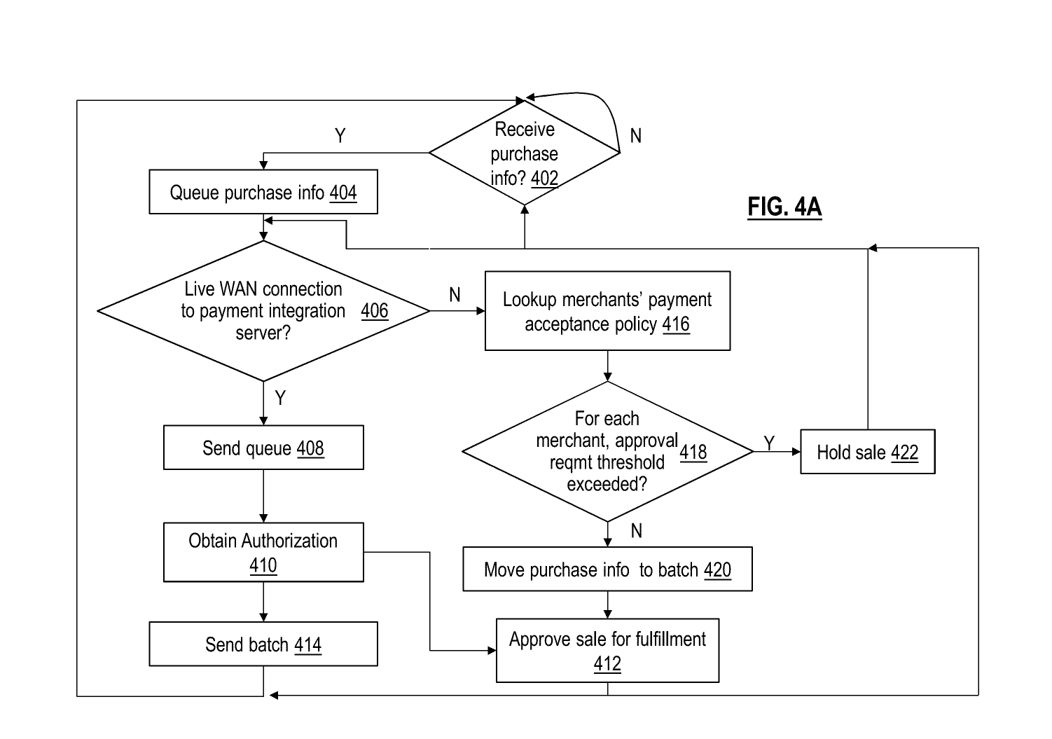

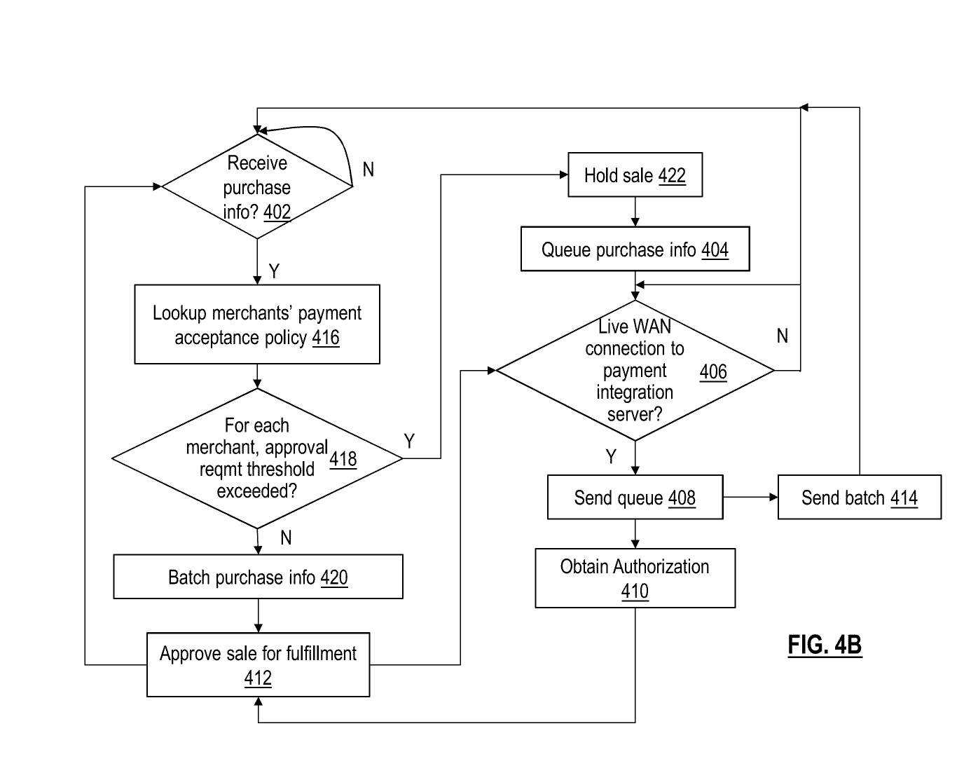

FIGS. 4A and 4B are flow diagrams illustrating example algorithms that may be executed by an onboard server to determine whether to authorize payments in the absence of a working WAN connection, and whether to transmit payment information using a high-priority queue or a lower-priority batch method.

In the embodiment of FIG. 4A, the process begins at 402 when the onboard server waits for purchase information from a client device. When such information is received, the process advances to 404, where the purchase information is immediately queued for high-priority transmission to the offboard payment integration server. At 406 a determination is made if the WAN connection is available to the payment integration server. In the affirmative case, the queued items are sent at 408, authorization is obtained at 410 from the payment integration server, and the sale is approved to be fulfilled at 412. Also, any batched data is sent over the live WAN connection at 414.

In the absence of an operational WAN connection, the process branches to 416, where the merchants' payment acceptance policies are looked up. The payment acceptance policy for each merchant may be different. This policy specifies the condition(s) under which payment may be approved in the absence of a working WAN connection. One example of such a condition is when a dollar amount is below a set limit. Various other considerations may be taken into account according to the policy of a given merchant. For example, the policy may specify a type of product for which payment may be authorized in conjunction with a defined value threshold. For instance, if a product is to be delivered to the purchaser onboard, then the payment can be authorized at a higher value than if the product is to be delivered after the transit period. A multitude of criteria may be applied, as defined by each merchant.

Accordingly, at 418, a decision is made by the onboard server as to whether each applicable merchant's approval requirement threshold is met or exceeded. In the negative case, i.e., the threshold is not met, which does not give rise to requiring actual approval through the payment integration server, the purchase information is batched for later, low-priority transmission when the WAN connection gets restored, and the sale is approved at 412. Otherwise, if actual approval is required according to the decision at 418, then the sale is held in abeyance at 422, and approval is postponed until an actual inquiry can be made via the WAN.

FIG. 4B is a variation of the embodiment of FIG. 4A. For consistency, each operational block is numbered the same as its corresponding operational block in FIG. 4A, except that the ordering of blocks is varied to produce a different algorithm. Whereas in the embodiment of FIG. 4A every purchase made while the WAN is operational is transmitted for actual authorization to the offboard payment integration server, the embodiment of FIG. 4B first inquires as to whether the applicable merchants' approval requirement threshold is met or exceeded. When actual approval is not needed, this algorithm simply accepts instant approval made onboard, and processes the payment using the low-priority batching mode.

Accordingly, at 402, when purchase information is received, the process proceeds to 416 to look up the applicable merchants' payment acceptance policies. Next, decision 418 is made to check if the current circumstances cause the merchant's requirement threshold to be exceeded. In the case where the threshold is not exceeded (i.e., actual approval is not needed), the purchase information is batched for low-priority transmission, and the sale of each item is approved for fulfillment.

When the approval requirement threshold is met or exceeded at 418, the process branches to 422, where sales of products requiring the authorization are held, and queued for high-priority transmission at the next available opportunity following restoration of the WAN connection. Decision 406 determines when the connection is present. In the presence of a live connection, the queued items are sent at 408, authorization is obtained at 410, and the sale is approved for fulfillment at 412. Also, the batched items are sent at 414.

Notably, in both exemplary algorithms, only the sales for specific products from specific merchants requiring actual approval in the absence of a working WAN connection are held up. The remaining sales of products from the same shopping cart, which can be instantly approved by the onboard server, are allowed to proceed. When an sale is held up, the system can notify the purchaser via his or her client device, as well as distribute records to any point-of-sale devices maintained by the crew.

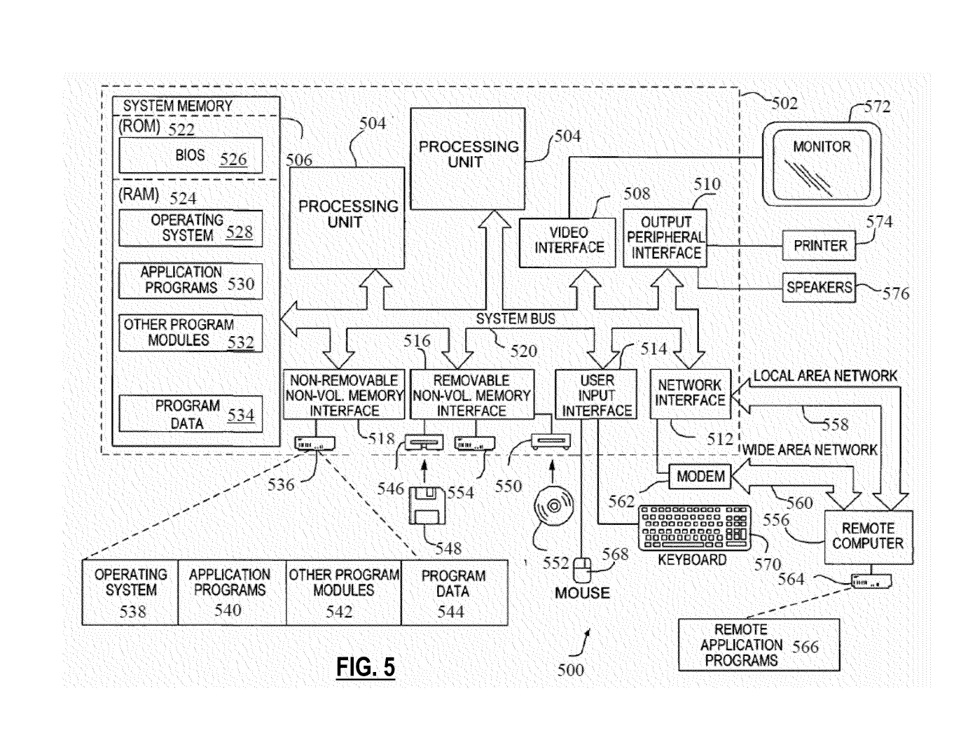

FIG. 5 is a diagram illustrating in greater detail a computer system 500 on which aspects of the invention as described herein may be implemented according to various embodiments. The computer system 500, portions of which can be used to implement any of the computing devices discussed above, such as the onboard server, client devices, etc., may include a computing device such as a personal computer 502. The personal computer 502 includes one or more processing units 504, a system memory 506, a video interface 508, an output peripheral interface 510, a network interface 512, a user input interface 514, removable 516 and non-removable 518 memory interfaces and a system bus or high-speed communications channel 520 coupling the various components. In various embodiments, the processing units 504 may have multiple logical cores that are able to process information stored on computer readable media such as the system memory 506 or memory attached to the removable 516 and non-removable 518 memory interfaces 518. The computer 502 system memory 506 may include non-volatile memory such as Read Only Memory (ROM) 522 or volatile memory such as Random Access Memory (RAM) 524. The ROM 522 may include a basic input/output system (BIOS) 526 to help communicate with the other portion of the computer 502. The RAM 524 may store portions of various software applications such as the operating system 528, application programs 530 and other program engines 532. Further, the RAM 524 may store other information such as program or application data 534. In various embodiments, the RAM 524 stores information that requires low-latencies and efficient access, such as programs and data being manipulated or operated on. In various embodiments RAM 524 comprises Double Data Rate (DDR) memory, Error Correcting memory (ECC) or other memory technologies with varying latencies and configurations such as RAMBUS or DDR2 and DDR3. In this way, in various embodiments, the system memory 506 may store the input data store, access credential data store, operating memory data store, instruction set data store, analysis result data store and the operating memory data store. Further, in various embodiments, the processing units 504 may be configured to execute instructions that limit access to the aforementioned data stores by requiring access credential before access to the information is granted.

The removable 516 and non-removable 518 memory interfaces may couple the computer 502 to disk drives 536 such as SSD or rotational disk drives. These disk drives 536 may provide further storage for various software applications such as the operating system 538, application programs 540 and other program engines 542. Further, the disk drives 536 may store other information such as program or application data 544. In various embodiments, the disk drives 536 store information that doesn't require the same low-latencies as in other storage mediums. Further, the operating system 538, application program 540 data, program engines 542 and program or application data 544 may be the same information as that stored in the RAM 524 in various embodiments mentioned above or it may be different data potentially derivative of the RAM 524 stored data.

Further, the removable non-volatile memory interface 516 may couple the computer 502 to magnetic portable disk drives 546 that utilize magnetic media such as the floppy disk 548, Iomega® Zip or Jazz, or optical disk drives 550 that utilize optical media 552 for storage of computer readable media such as Blu-Ray®, DVD-R/RW, CD-R/RW and other similar formats. Still other embodiments utilize SSD or rotational disks housed in portable enclosures 54 to increase the capacity of removable memory.

The computer 502 may utilize the network interface 512 to communicate with one or more remote computers 556 over a local area network (LAN) 558 or a wide area network (WAN) 560. The network interface 512 may utilize a Network Interface Card (NIC) or other interface such as a modem 562 to enable communication. The modem 562 may enable communication over telephone lines, coaxial, fiber optic, powerline, or wirelessly. The remote computer 556 may contain a similar hardware and software configuration or may have a memory 564 that contains remote application programs 566 that may provide additional computer readable instructions to the computer 502. In various embodiments, the remote computer memory 564 can be utilized to store information such as identified file information that may be later downloaded to local system memory 506. Further, in various embodiments the remote computer 556 may be an application server, an administrative server, client computers, or a network appliance.

A user may enter information to the computer 502 using input devices connected to the user input interface 514 such as a mouse 568 and keyboard 570. Additionally, the input device may be a trackpad, fingerprint scanner, joystick, barcode scanner, media scanner or the like. The video interface 508 may provide visual information to a display such as a monitor 572. The video interface 508 may be an embedded interface or it may be a discrete interface. Further, the computer may utilize a plurality of video interfaces 508, network interfaces 512 and removable 516 and non-removable 518 interfaces in order to increase the flexibility in operation of the computer 502. Further, various embodiments utilize several monitors 572 and several video interfaces 508 to vary the performance and capabilities of the computer 502. Other computer interfaces may be included in computer 502 such as the output peripheral interface 510. This interface may be coupled to a printer 574 or speakers 576 or other peripherals to provide additional functionality to the computer 502.

Various alternative configurations and implementations of the computer 502 are within the spirit of the invention. These variations may include, without limitation, additional interfaces coupled to the system bus 520 such as universal serial bus (USB), printer port, game port, PCI bus, PCI Express or integrations of the various components described above into chipset components such as the northbridge or southbridge. For example, in various embodiments, the processing unit 504 may include an embedded memory controller (not shown) to enable more efficient transfer of data from the system memory 506 than the system bus 520 may provide.

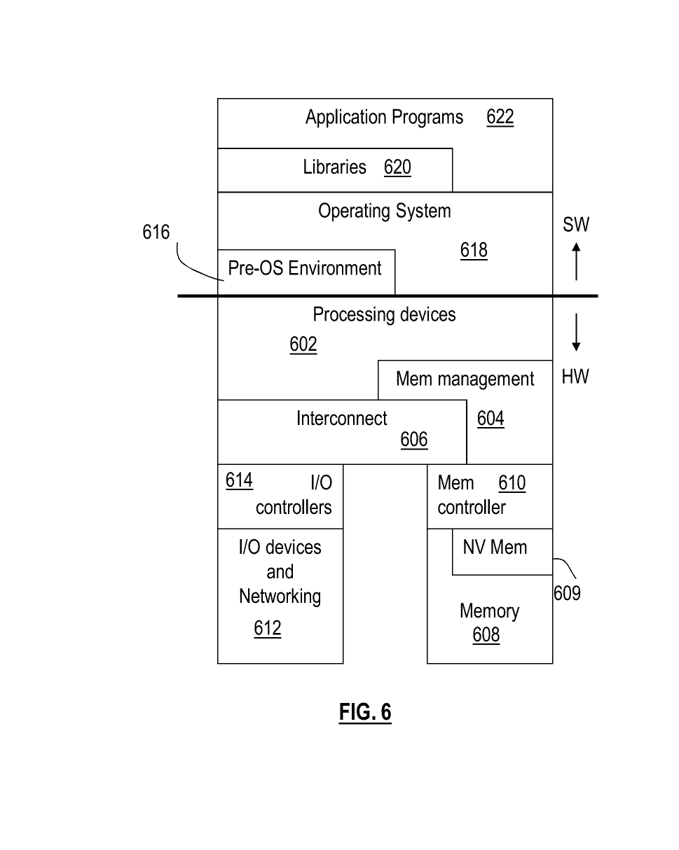

FIG. 6 is a diagram illustrating an exemplary hardware and software architecture of a computer system such as the one depicted in FIG. 5, in which various interfaces between hardware components and software components are shown. As indicated by HW, hardware components are represented below the divider line, whereas software components denoted by SW reside above the divider line. On the hardware side, processing devices 602 (which can include one or more microprocessors, digital signal processors, etc., each having one or more processor cores, are interfaced with memory management device 604 and system interconnect 606. Memory management device 604 provides mappings between virtual memory used by processes being executed, and the physical memory. Memory management device 604 can be an integral part of a central processing unit which also includes the processing devices 602.

Interconnect 606 includes the memory, data, and control busses, as well as the interface with peripherals, e.g., PCI, USB, etc. Memory 608 (e.g., dynamic random access memory —DRAM) and non-volatile memory 609 such as flash memory (i.e., electrically-erasable read-only memory—EEPROM) are interfaced with memory management device 604 and interconnect 606 via memory controller 610. This architecture can support direct memory access (DMA) by peripherals. I/O devices, including video and audio adapters, disk storage, external peripheral busses such as USB, Bluetooth, etc, as well as network interface devices such as those communicating via Ethernet or Wi-Fi interfaces, are collectively represented as I/O devices and networking 612, which interface with interconnect 606 via corresponding I/O controllers 614.

On the software side, a pre-operating system (pre-OS) environment 616, which is executed at initial system start-up and is responsible for initiating the boot-up of the operating system. One traditional example of pre-OS environment 616 is a system basic input/output system (BIOS). In present-day systems, a unified extensible firmware interface (UEFI) is implemented. Pre-OS environment 616, described in greater detail below, is responsible for initiating the launching of the operating system, but also provides an execution environment for embedded applications according to certain aspects of the invention. Operating system 618 provides a kernel that controls the hardware devices, manages memory access for programs in memory, coordinates tasks and facilitates multi-tasking, organizes data to be stored, assigns memory space and other resources, loads program binary code into memory, initiates execution of the application program which then interacts with the user and with hardware devices, and detects and responds to various defined interrupts. Also, operating system 618 provides device drivers, and a variety of common services such as those that facilitate interfacing with peripherals and networking, that provide abstraction for application programs so that the applications do not need to be responsible for handling the details of such common operations. Operating system 618 additionally provides a graphical user interface (GUI) that facilitates interaction with the user via peripheral devices such as a monitor, keyboard, mouse, microphone, video camera, touchscreen, and the like.

Libraries 620 include collections of program functions that provide further abstraction for application programs. These include shared libraries, dynamic linked libraries (DLLs), for example. Libraries 620 can be integral to the operating system 618, or may be added-on features, or even remotely-hosted. Libraries 620 define an application program interface (API) through which a variety of function calls can be made by application programs to invoke the services provided by the operating system 618. Application programs 622 are those programs that perform useful tasks for users, beyond the tasks performed by lower-level system programs that coordinate the basis operability of the computer system itself.

The embodiments above are intended to be illustrative and not limiting. Additional embodiments are within the claims. In addition, although aspects of the present invention have been described with reference to particular embodiments, those skilled in the art will recognize that changes can be made in form and detail without departing from the scope of the invention, as defined by the claims.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as will be understood by persons of ordinary skill in the art.

Any incorporation by reference of documents above is limited such that no subject matter is incorporated that is contrary to the explicit disclosure herein. Any incorporation by reference of documents above is further limited such that no claims that are included in the documents are incorporated by reference into the claims of the present application. The claims of any of the documents are, however, incorporated as part of the disclosure herein, unless specifically excluded. Any incorporation by reference of documents above is yet further limited such that any definitions provided in the documents are not incorporated by reference herein unless expressly included herein.

For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed is:

1. A mobile retailing computing infrastructure comprising:
an onboard server situated in a public transportation vehicle, the onboard server including computing hardware including a processor, data storage, and communication circuitry, the data storage containing instructions that, when executed by the computing hardware, cause the computing hardware to:
establish communication with a plurality of client devices over a local area network, each client device including a mobile retailing engine that causes the client device to display products offered for sale from multiple different merchants and to execute a user-interactive electronic shopping cart process that coordinates a purchase transaction in which payment is accepted from a user in exchange for a user-selected plurality of products from a plurality of the different merchants;
execute a payment processing engine to obtain customer information, purchased product information, and payment information from each of the plurality of client devices in response to entry of a purchase and payment in that client device;
establish communication with a centralized payment integration server over a wide-area network connection to transmit transaction customer information, purchased products information, and payment information, such that the centralized payment integration server processes payment transactions with a plurality of different acquiring banks corresponding to different ones of the plurality of merchants.

2. The mobile retailing computing infrastructure of claim 1, wherein the payment processing engine aggregates the customer information, purchased products information, and payment information from each of the plurality of client devices into a single batch of purchase records to be transmitted to the centralized payment integration server.

3. The mobile retailing computing infrastructure of claim 1, further comprising:
an additional onboard server situated in the public transportation vehicle and executing a second payment processing engine to obtain second customer information, second purchased products information, and second payment information from at least one other client device in response to entry of a purchase and payment in that other client device;
the additional onboard server configured to establish communication with said onboard server over the local area network, and to replicate purchase information with said onboard server for the plurality of client devices and the at least one other client device.

4. A mobile retailing computing infrastructure comprising:
an onboard server situated in a public transportation vehicle, the onboard server including a processor, data storage, and communication circuitry, the data storage containing instructions that, when executed by the computing hardware, cause the computing hardware to:
establish communication with a plurality of client devices over a local area network, each client device including a mobile retailing engine that causes the client device to display products offered for sale and to execute a user-interactive electronic shopping cart process that coordinates an initiated purchase transaction in which payment is accepted from a user in exchange for a user-selected plurality of products from at least one merchant;
execute a payment processing engine to obtain customer information, purchased product information, and payment information from each of the plurality of client devices in response to entry of a purchase and payment in that client device;
execute a data replication engine to synchronize the obtained customer information, purchased product information, and payment information with the plurality of client devices such that:
for every one of the plurality of client devices that is uniquely associated with a particular at least one user, only information relating to that at least one user is synchronized; and
for every one of the plurality of client devices that is not uniquely associated with a particular at least one user, information relating to all users having initiated purchase transactions is synchronized;
establish communication with a centralized payment integration server over a wide-area network connection to transmit transaction customer, purchased products information, and payment information, such that the centralized payment integration server processes payment transactions with at least one acquiring bank corresponding to the at least one merchant.

5. The mobile retailing computing infrastructure of claim 4, wherein the at least one merchant includes a plurality of different merchants, each having a different payment processing policy, and wherein the centralized payment integration server processes payment transaction with a plurality of different acquiring banks corresponding to each different payment processing policy.

6. The mobile retailing computing infrastructure of claim 4, further comprising:
an additional onboard server situated in the public transportation vehicle and executing a second payment processing engine to obtain second customer information, second purchased product information, and second payment information from at least one other client device in response to entry of a purchase and payment in that other client device;
said onboard server and the additional onboard server each being configured to establish communication with one another over the local area network, and to replicate purchase information with said onboard server for the plurality of client devices and the at least one other client device.

7. A mobile retailing computing infrastructure comprising:
an onboard server situated in a public transportation vehicle, the onboard server including computing hardware including a processor, data storage, and communication circuitry, the data storage containing instructions that, when executed by the computing hardware, cause the computing hardware to:
establish communication with a plurality of client devices over a local area network, each client device executing a mobile retailing engine that causes the client device to:
display products offered for sale by a plurality of different merchants, each merchant being associated with a specific payment acceptance policy; and
execute a user-interactive electronic shopping cart process that coordinates an initiated purchase transaction in which payment is accepted from a user in exchange for a user-selected set of at least one product from at least one merchant of the plurality of merchants;
execute a payment processing engine to:
obtain customer information, purchased product information, and payment information from each of the plurality of client devices in response to entry of a purchase and payment in that client device;
read the specific payment acceptance policy corresponding to the at least one merchant from which the at least one product is to be purchased according to the initiated purchase transaction;
for each of the at least one merchant, compute a comparison of the corresponding specific payment acceptance policy against the initiated purchase transaction to determine whether a purchase approval requirement condition is met;
in response to the comparison indicating that the purchase approval requirement is not met, generate an approval of the initiated purchase transaction;
in response to the comparison indicating that the purchase approval requirement is met, obtain a transaction authorization via wide-area network communication with a centralized payment integration server, wherein the payment integration server processes payment transactions with at least one acquiring bank corresponding to the at least one merchant.

8. The mobile retailing computing infrastructure of claim 7, wherein the payment processing engine is configured to check for a presence of a working wide-area network connection between the onboard server and the payment integration server and, in response to an indication of a presence of the working wide-area network connection, to obtain the transaction authorization via the wide-area network communication with the centralized payment integration server prior to the comparison of the corresponding specific payment acceptance policy against the initiated purchase transaction.

9. The mobile retailing computing infrastructure of claim 7, wherein the payment processing engine is configured to check for a presence of a working wide-area network connection between the onboard server and the payment integration server in response to the comparison of the corresponding specific payment acceptance policy against the initiated purchase transaction to determine whether a purchase approval requirement condition is met.

10. The mobile retailing computing infrastructure of claim 7, wherein the payment processing engine is configured to schedule a low-priority batch transmission of the customer information, purchased product information, and payment information relating to the initiated purchase transaction to the payment integration server in response to the comparison indicating that the purchase approval requirement is not met, wherein the low-priority batch transmission includes other transaction information corresponding to at least one other purchase transaction; and
wherein the payment processing engine is configured to schedule a high-priority transmission of the customer information, purchased product information, and payment information relating to the initiated purchase transaction to the payment integration server in response to the comparison indicating that the purchase approval requirement is met, wherein the high-priority transmission contains only transaction information corresponding to the initiated purchase transaction.

11. A method for autonomously operating a mobile retailing computing system, the method comprising:
by an onboard server situated in a public transportation vehicle:
establishing communication with a plurality of client devices over a local area network, each client device displaying products offered for sale from multiple different merchants and executing a user-interactive electronic shopping cart process that coordinates a purchase transaction in which payment is accepted from a user in exchange for a user-selected plurality of products from a plurality of the different merchants;
obtaining customer information, purchased product information, and payment information from each of the plurality of client devices in response to entry of a purchase and payment in that client device;
establishing communication with a centralized payment integration server over a wide-area network connection to transmit transaction customer information, purchased products information, and payment information, such that the centralized payment integration server processes payment transactions with a plurality of different acquiring banks corresponding to different ones of the plurality of merchants.

12. The method of claim 11, further comprising:
aggregating, by the onboard server, the customer information, purchased products information, and payment information from each of the plurality of client devices into a single batch of purchase records to be transmitted to the centralized payment integration server.

13. The method of claim 11, further comprising:
by an additional onboard server situated in the public transportation vehicle:
obtaining second customer information, second purchased products information, and second payment information from at least one other client device in response to entry of a purchase and payment in that other client device; and
establishing communication with said onboard server over the local area network, and replicating purchase information with said onboard server for the plurality of client devices and the at least one other client device.

14. A method for autonomously operating a mobile retailing computing system, the method comprising:
by an onboard server situated in a public transportation vehicle:
establishing communication with a plurality of client devices over a local area network, each client device displaying products offered for sale and executing a user-interactive electronic shopping cart process that coordinates an initiated purchase transaction in which payment is accepted from a user in exchange for a user-selected plurality of products from at least one merchant;
obtaining customer information, purchased product information, and payment information from each of the plurality of client devices in response to entry of a purchase and payment in that client device;
synchronizing the obtained customer information, purchased product information, and payment information with the plurality of client devices such that:
for every one of the plurality of client devices that is uniquely associated with a particular at least one user, only information relating to that at least one user is synchronized; and
for every one of the plurality of client devices that is not uniquely associated with a particular at least one user, information relating to all users having initiated purchase transactions is synchronized;
establishing communication with a centralized payment integration server over a wide-area network connection to transmit transaction customer, purchased products information, and payment information, such that the centralized payment integration server processes payment transactions with at least one acquiring bank corresponding to the at least one merchant.

15. The method of claim 14, wherein the at least one merchant includes a plurality of different merchants, each having a different payment processing policy, and wherein the centralized payment integration server processes payment transaction with a plurality of different acquiring banks corresponding to each different payment processing policy.

16. The method of claim 14, further comprising:
by an additional onboard server situated in the public transportation vehicle:
obtaining second customer information, second purchased products information, and second payment information from at least one other client device in response to entry of a purchase and payment in that other client device;
establishing, communication between the additional onboard server and said onboard server over the local area network, and replicating purchase information with said onboard server for the plurality of client devices and the at least one other client device.

17. A method for autonomously operating a mobile retailing computing system, the method comprising:
by an onboard server situated in a public transportation vehicle:
establishing communication with a plurality of client devices over a local area network, each client device executing a mobile retailing engine that causes the client device to:
display products offered for sale by a plurality of different merchants, each merchant being associated with a specific payment acceptance policy; and
execute a user-interactive electronic shopping cart process that coordinates an initiated purchase transaction in which payment is accepted from a user in exchange for a user-selected set of at least one product from at least one merchant of the plurality of merchants;
obtaining customer information, purchased product information, and payment information from each of the plurality of client devices in response to entry of a purchase and payment in that client device;
reading the specific payment acceptance policy corresponding to the at least one merchant from which the at least one product is to be purchased according to the initiated purchase transaction;
for each of the at least one merchant, computing a comparison of the corresponding specific payment acceptance policy against the initiated purchase transaction to determine whether a purchase approval requirement condition is met;
in response to the comparison indicating that the purchase approval requirement is not met, generating an approval of the initiated purchase transaction;
in response to the comparison indicating that the purchase approval requirement is met, obtaining a transaction authorization via wide-area network communication with a centralized payment integration server, wherein the payment integration server processes payment transactions with at least one acquiring bank corresponding to the at least one merchant.

18. The method of claim 17, further comprising:
by the onboard server, checking for a presence of a working wide-area network connection between the onboard server and the payment integration server and, in response to an indication of a presence of the working wide-area network connection, obtaining the transaction authorization via the wide-area network communication with the centralized payment integration server prior to the comparison of the corresponding specific payment acceptance policy against the initiated purchase transaction.

19. The method of claim 17, further comprising:
by the onboard server, checking for a presence of a working wide-area network connection between the onboard server and the payment integration server in response to the comparison of the corresponding specific payment acceptance policy against the initiated purchase transaction, determining whether a purchase approval requirement condition is met.

20. The method of claim 17, further comprising:
by the onboard server:
scheduling a low-priority batch transmission of the customer information, purchased product information, and payment information relating to the initiated purchase transaction to the payment integration server in response to the comparison indicating that the purchase approval requirement is not met, wherein the low-priority batch transmission includes other transaction information corresponding to at least one other purchase transaction; and
scheduling a high-priority transmission of the customer information, purchased product information, and payment information relating to the initiated purchase transaction to the payment integration server in response to the comparison indicating that the purchase approval requirement is met, wherein the high-priority transmission contains only transaction information corresponding to the initiated purchase transaction.
